(19) United States
(12) Patent Application Publication
(10) Pub. No.: US 2008/0082436 A1
(43) Pub. Date: Apr. 3, 2008

(54) System And Method For Creating And Trading A Digital Derivative Investment Instrument

(76) Inventors: Catherine T. Shalen, Chicago, IL (US); Joanne Moffic-Silver, Chicago, IL (US)

Correspondence Address: BRINKS HOFER GILSON & LIONE, P.O. BOX 10395, CHICAGO, IL, 60610, US

(21) Appl. No.: 11/770,705

(22) Filed: Jun. 28, 2007

Related U.S. Application Data
(63) Continuation-in-part of application No. 11/122,659, filed on May 4, 2005.
(60) Provisional application No. 60/817,434, filed on Jun. 28, 2006.
(60) Provisional application No. 60/859,824, filed on Nov. 17, 2006.

(51) Int. Cl. G06Q 40/00; G06F 17/30; G06F 17/40

(52) U.S. Cl. 705/36 R; 705/37

(57) ABSTRACT

A method and system for creating and trading an investment instrument based on an initial public offering of an entity is disclosed that allows investors to take risk positions relative to the occurrence or non-occurrence of a contingent binary event. The contingent binary event will have one of two possible outcomes. In a digital derivative contract, a long investor agrees to pay a short investor a contract amount in return for the short investor agreeing to pay the long investor one of two different settlement amounts depending on the outcome as the contingent binary event. Typically, one settlement amount will be zero and the other will be an amount greater than the digital derivative contract price.

### CROSS-REFERENCE TO RELATED PATENT APPLICATIONS

This application is a Continuation-In-Part of pending U.S. application Ser. No. 11/22,659, filed May 4, 2005, and claims the benefit of pending U.S. Provisional Application Nos. 60/817,434, filed Jun. 28, 2006 and 60/859,824, filed Nov. 17, 2006. All of the aforementioned applications are incorporated herein by reference in their entirety.

### TECHNICAL FIELD

The present disclosure relates to methods of creating and trading derivative contracts whose value depends on the occurrence or non-occurrence of specified events.

### BACKGROUND

Traditional derivatives contracts are well known investment instruments. A buyer can purchase the right to receive delivery of an underlying commodity or asset on a specified date in the future. Conversely, a seller agrees to deliver the commodity or asset to an agreed location on the specified date. For example, futures contracts originally developed in the trade of agricultural commodities. Large consumers of agricultural products seeking to secure their future supply of raw ingredients like corn, wheat and other commodities would pay in advance for guaranteed delivery in the future. Producers in turn would sell in advance to raise capital to finance the cost of production. The success of agricultural futures soon led to futures activity surrounding other commodities as well. Today futures contracts are traded on everything from pork bellies to memory chips, and from stock shares to market indices.

Over the years derivatives contracts, such as options and futures, have evolved from simply a means of securing delivery of a commodity or other asset into sophisticated investment instruments. Because derivatives contracts establish commodity or asset must be delivered, subsequent changes in the price of the underlying asset will inure to the benefit of one party and to the detriment of the other. If the price rises above the negotiated price, the seller is obligated to deliver the commodity or asset at the lower agreed upon price. The buyer may then resell the received product at the higher market price to realize a profit. The seller in effect loses the difference between the negotiated contract price and the market price on the date the goods are delivered. Conversely if the price of the underlying commodity or asset falls below the negotiated price, the seller can obtain the commodity or asset at the lower market price for delivery to the buyer while retaining the higher negotiated price. In this case the seller realizes a profit in the amount of the difference between the current market price on the delivery date and the negotiated contract price. The buyer sees an equivalent loss.

As the preceding discussion makes clear, derivatives contracts lend themselves to speculating in price movements of the underlying commodity or other asset. Investors may be interested in taking a “long” position in a commodity or asset, buying today at the present price for delivery in the future, in anticipation that prices for the commodity or asset will rise prior to the delivery date. Conversely investors may wish to take a short position, agreeing to deliver the commodity or asset on the delivery date at a price established today, in anticipation of falling prices.

As futures contracts have evolved away from merely a mechanism for securing future delivery of a commodity into sophisticated investment instruments, they have become more and more abstracted from the underlying assets on which they are based. Whereas futures contracts originally required actual delivery of the underlying commodity on the specified delivery date, today's derivatives contracts do not necessarily require assets to change hands. Instead, derivatives contracts may be settled in cash. Rather than delivering the underlying asset, cash settlement requires that the difference between the market price on the delivery date and the contract price be paid by one investor to the other, depending on which direction the market price has moved. If the prevailing market price is higher than the contract price, the investor who has taken a short position in the derivatives contract must pay the difference between the market price on the delivery date and the contract price to the long investor. Conversely, if the market price has fallen, the long investor must pay the difference between the contract price and the market price to the short investor in order to settle the contract.

Cash settlement allows further abstraction of derivatives contracts away from physical commodities or discrete units of an asset such as stock shares. Today derivatives contracts are traded on such abstract concepts as market indices and interest rates Derivatives contracts on market indices are a prime example of the level of abstraction derivatives contracts have attained. Delivery of the underlying asset is impossible for a derivatives contract based on a market index such as the S&P 500. No such asset exists. However, cash settlement allows derivatives contracts to be written which allow investors to take positions relative to future movements in the value of an index, or other variable market indicators. A derivatives price is established based on a target value of the index on a specified “delivery” date. The difference between the target value price and the actual value of the index (often multiplied by a specified multiplier) is exchanged between the long and short investors in order to settle the contract. Traditionally, cash settlement occurs on the last day of trading for a particular contract. Thus, if the actual value of the index rises above the target value, the short investor must pay to the long investor an amount equal to the difference between the actual value and the target value times the specified multiplier. Conversely if the actual index value falls below the target value, the long investor must pay to the short investor the difference between the actual value and the target value multiplied by the multiplier.

The value of traditional derivatives contracts is inherently tied to the market price or value of the underlying asset and the agreed upon settlement price. The market value of the underlying asset itself, however, may be influenced by any number of external factors. For example, the amount of rainfall in Iowa in June could affect the value of corn derivatives for September delivery. The latest national productivity report may have a positive or negative impact on S&P 500 derivatives. If the share price of a particular company reaches a certain value, it may impact the price investors are willing to pay for derivatives based on that company's shares. The factors that influence the value of traditional derivatives contracts may also have an impact on other investments and assets. For example, if the share price of a market leader in a certain economic sector were to reach a certain value, it may signal to investors that the whole sector is poised for significant growth and may pull up the share price of other companies in the same sector. Likewise, an unexpected change in interest rates by the Federal Reserve may affect share prices broadly throughout the capital markets.

When investors wish to take positions based on the occurrence or non-occurrence of various contingent events that may have broad impact across any number of individual investments, they may take a number of positions in various investments which the investor believes will all be affected in the same way by the occurrence or non-occurrence of a specific event.

### SUMMARY

A problem with the approach noted above is that the individual investments in which the investor takes a position may be influenced by factors other than the occurrence or non-occurrence of the specified event. Further, each individual investment may be affected differently by the occurrence or non-occurrence of the specified event. Thus, the investor may not be able to fully isolate the economic impact that the occurrence or non-occurrence of a specified event may have, and directly invest in what he or she perceives to be the likely outcome of the event. In order to provide for investing based on the occurrence or non-occurrence of certain events, methods for creating and trading digital derivative contracts, as well as methods and systems for trading such contracts on an exchange, such as a parimutuel exchange, are disclosed. A digital options contract is an investment instrument in which investors can take risk positions based on the probable occurrence or non-occurrence of an event. In exchange for receiving a predetermined premium price from the long investor, a short investor in a digital option contract agrees to pay one of two specified settlement amounts to the long investor depending on the state of a binary variable at the expiration of the contract. If the binary variable does not occur, the short investor keeps the option price. However, if the binary variable does occur, the short investor pays the amount specified in the contract to the long investor. Typically the settlement amounts will be $0 and some other value greater than the digital option price. Thus, if the state of the binary variable is a first value, the short investor pays nothing to the long investor, and if the binary variable is a second value, the short investor pays the second amount less the option price.

According to a first aspect of the invention, a method of trading a financial instrument is disclosed. The method includes identifying an initial public offering for a digital option contract and establishing the digital option contract in which an investor will receive one of a first settlement amount and a second settlement depending on whether a strike price of the digital option contract is less than, equal to, or greater than a share value of the initial public offering at expiration of the digital option contract. The method further includes determining whether the strike price of the digital option contract is less than, equal to, or greater than the share value of the initial public offering at expiration of the digital option contract and settling the digital option contract according to whether the strike price of the digital option contract is less than, equal to, or greater than the share value of the initial public offering at expiration of the digital option contract.

In another aspect of the invention, a computer-readable medium is disclosed. The computer readable medium includes processor executable program instructions for executing the steps for creating and trading a digital derivative contract based on an initial public offering of an entity. The instructions include instruction for identifying an entity subject to an initial public offering and establishing a digital derivative contract in which an investor will receive one of a first settlement amount and a second settlement amount depending on whether a strike price of the digital derivative contract is less than, equal to, or greater than a share value of the initial public offering. Instructions are also included for settling the digital derivative contract according to whether the strike price of the digital derivative contract is less than, equal to, or greater than the share value of the initial public offering at expiration of the digital derivative contract.

In yet another aspect of the invention, an exchange configured for trading a digital derivative investment instrument based on an underlying initial public offering share value by a combination of electronic and open-outcry trading mechanisms is disclosed. The exchange includes an interface for receiving an incoming order to purchase the digital derivative investment instrument based on the underlying initial public offering share value, the incoming order having an associated size and a payout value.

A book memory stores a plurality of previously received orders, the previously received orders each having an associated size and a payout value. The exchange includes a system memory adapted to store predefined condition parameters for at least one defined state corresponding to at least one potential outcome for the digital derivative investment instrument, as well as a processor adapted to allocate orders among the plurality of previously received orders in the book memory based on the condition parameters wherein the condition parameters include at least one parameter for identifying an occurrence of at least one defined state occurring before the expiration. The processor is further adapted to calculate a zero payout value for orders having the at least one defined state that did not occur before an expiration of the digital derivative investment instrument based on the underlying initial public offering share value and a greater than zero payout value for orders having at least one defined state that did occur prior to the expiration of the digital derivative investment instrument based on the underlying initial public offering share value.

Other systems, methods, features and advantages of the invention will be, or will become, apparent to one with skill in the art upon examination of the following figures and detailed description.

### BRIEF DESCRIPTION OF THE DRAWINGS

FIG. 1 is a flow chart showing a method of creating a digital derivatives contract.

FIG. 2 is a sample listing of digital derivative contracts.

FIG. 3 is a block diagram of a system for trading digital derivative contracts.

FIG. 4 is a block diagram of exchange backend systems for supporting the trading of digital derivatives contracts.

FIG. 5 is a flow chart showing a method of conducting an automated auction.

FIG. 6 is a block diagram of an automated exchange configured for auctioning of digital contracts.

### DETAILED DESCRIPTION

The present disclosure relates to a financial instrument in which investors may take positions on the contingent state of a binary variable at a specified time in the future, and a system for trading such instruments. In one embodiment, the financial instrument may be considered a “digital” derivatives contract in that it will settle at one of two different settlement amounts in the future based on the state of a binary variable at expiration. As with traditional derivatives contracts, a digital derivatives contract according to the present invention is merely a set of mutual promises between two parties—a first investor who desires to take a long position with regard to the eventual state of a particular binary variable and a second investor who desires to take a short position with regard to the eventual state of the binary variable. The long investor agrees to pay a certain amount, the negotiated price, to the short investor in exchange for the short investor agreeing to pay to the long investor one of the two different settlement amounts depending on the state of the binary variable when the contract is settled. Typically one of the two possible settlement values will be $0 and the other settlement value will be a non-zero value greater than the negotiated price.

Digital derivatives contracts are “digital” in that they may be created around virtually any question that will have only two possible answers: yes or no; true or false; 1 or 0; on or off; or the like. In general the digital derivatives contracts will be written around specific contingent events, events that may or may not occur. Typically the occurrence or non-occurrence of the specified event will be related to economic or market factors which investors may anticipate. For example a digital derivatives contract can be based on a binary variable that depends on whether the share price of a particular stock closes above a specified threshold on the expiration date of the contract. Conversely, a binary variable may depend on whether the share price closes below a specified threshold. Similarly, a binary variable can be established to determine whether a particular index or market indicator closes above or below a predefined threshold. Similar variables can be developed around economic indicators and interest rates. Alternatively, binary variables can be established based on whether a particular regulatory body takes a particular action or not. Will the Federal Reserve open market committee raise interest rates at its next meeting? Will the EPA bring an enforcement action against a particular company? Or the like. Specific examples of standard digital derivatives contracts may include for example, 30-year fixed mortgage rate digitals; Sweet Crude Oil digitals; CBOE Volatility Index (VIX) digitals; Gold digitals. The potential list of digital derivatives contracts is essentially limitless.

Another “digital” quality of the digital derivatives contracts is the binary nature of the settlement amounts. Whereas traditional derivatives contracts have settlement amounts that directly reflect the value of the underlying asset in relation to the negotiated price, digital derivatives have only two possible settlement amounts, each corresponding to one state of the binary variable. For example, if the state of the binary variable turns out to be “no”, the second the state of the binary variable turns out to be “yes” the second investor may be required to pay the second settlement amount to the first investor. In most cases one settlement amount will be zero and the other will be a substantial amount. Thus, the second investor will either pay the first investor nothing or a significant amount depending on the outcome of the binary variable. The first investor will be required to pay the negotiated price regardless. Thus, if the second investor is required to pay a non-zero amount, the negotiated price may be deducted from the settlement amount when the contract is settled.

Alternatively, a digital derivatives contract may be structured so that both the first investor and the second inventor deposit their maximum possible loss under the digital derivatives contract when the digital derivatives contract is formed. Then, as the binary variable turns out to be “no” or “yes,” the deposited amounts from the first or second investor shifts to the account of the investor holding the position corresponding to the result of the binary variable. For example, when a digital derivatives contract having a settlement value of $1,000 is formed, a first investor taking the long position deposits $400 and a second investor taking the short position deposits $600. At settlement after the binary variable turns out to be “no” or “yes,” one investor will have an account balance of $1,000 and the other investor will have an account balance of $0.

A hypothetical digital derivatives contract could be created around the binary question “Will the Dow Jones Industrial average close above 11,000 at the end of the second quarter of the present year?” Clearly, the answer to this question will be known on July 1, and it will be either yes or no. The investors entering into such a digital contract may agree on settlement amounts of $0 if the Dow closes at or below 11,000 and $100 if the Dow closes above 11,000. Further, the first investor may be willing to pay the second investor $70 for the right to receive either $0 or $100 depending on whether the Dow closes above 11,000 on July 1 or not. If on July 1 the Dow does not close above 11,000 the first investor pays the second investor $70 and the second investor owes the first investor nothing. Thus, the second investor, who took a short position in the contract, makes a $70 profit. The first investor, who took the long position, suffers a $70 loss. Contrarily, if the Dow does in fact close above $11,000 on July 1, the first investor is still obligated to pay the $70 derivatives price to the second investor, but now the second investor is obligated to pay the second settlement amount of $100. The $70 owed by the first investor may be deducted from the amount owed by the second investor. Thus, the second investor need actually pay only $30 to the first investor and the first investor need actually pay nothing. In this case the second investor suffers a $30 loss and the first investor sees a $30 gain. Thus in the present example, the first investor has placed $70 at risk with the opportunity to realize a $30 gain, whereas the second investor has placed $30 at risk with the opportunity to realize a $70 gain.

Of course in a real world scenario the amounts investors will be willing to risk on different positions will depend on how likely they perceive one result to be compared to the other. In the above example, for instance, if the stock market has been steadily rising and is approaching 11,000 investors may be less inclined to take the short position. This would tend to drive up the derivatives price in order to increase the possible return for the apparent increased risk that the Dow will in fact close above 11,000. Conversely, if the market has been stagnant and the Dow is nowhere near 1,000 it may be a good bet that it will not close above $11,000 by the end of the second quarter. Accordingly, investors may be less willing to take the long position thereby driving down the derivatives price.

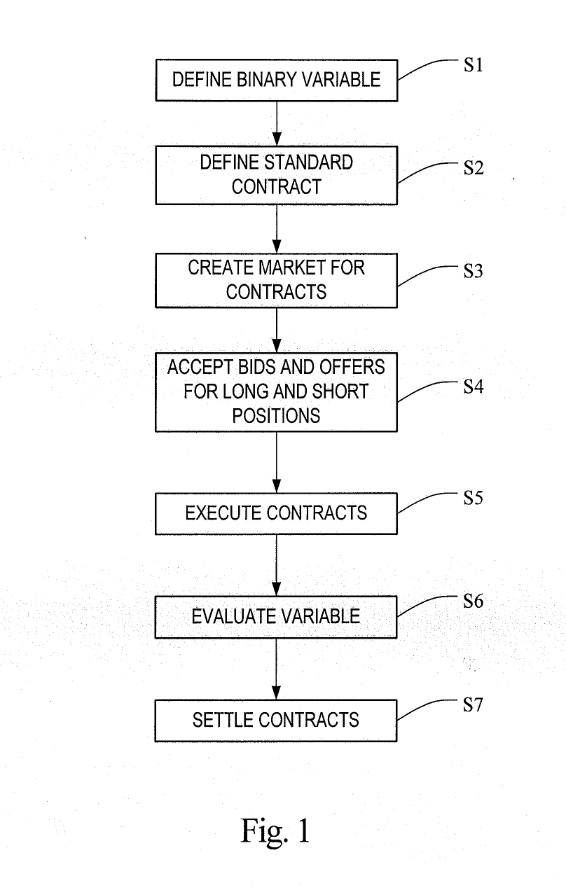

FIG. 1 shows a flow chart of a method of creating and trading a digital derivatives contracts according to the present invention. The first step S1 is to define a binary variable that may take on one of two different states at a time in the future (i.e. at expiration). The second step S2 is to define a standard digital derivatives contract. The standard contract will define the binary variable, establish both the first and second settlement amounts, and specify the expiration date of the contract. The price for the digital derivatives contracts based on the standard contract will be established in the open market. Step S3 is to create a market for the digital derivatives contracts. Step S4 is to accept bids, offers and purchase orders for both long and short positions in digital derivatives contracts which are to be created according to the standard digital derivatives contract. Step S5 is to execute digital derivatives contracts by matching corresponding orders for long and short positions. In step S6 the binary variable is evaluated at the expiration of the contract, and in step S7 the contract is settled.

Regarding step S6, it is also contemplated that the binary variable may also be evaluated at any time prior to expiration, so that other contract formats are possible. For example, if, at any time prior to expiration, the binary variable is in-the-money, then a payout can be realized at expiration.

It is intended that digital derivatives contracts according to the present invention will be traded on an exchange. The exchange may be a traditional open outcry exchange, an electronic exchange or trading platform, or a hybrid exchange (both an open outcry and electronic) such as the Chicago Board Options Exchange (CBOE) or CBOE Futures Exchange (CFE). Employing the method outlined in FIG. 1, the exchange may from time to time identify binary variables in which it believes investors will be interested in taking positions. For example, the exchange may determine that investors will be interested in taking positions relative to the movement of 30-year fixed mortgage rates relative to one or more threshold values, or the price of a commodity such as sweet crude oil prices or gold prices, again relative to one or more price thresholds. Alternatively, the exchange may determine that investors are interested in taking positions regarding the movements of a particular index such as the CBOE volatility index (VIX), relative to certain significant threshold values.

In cases where the binary variable relates to the price or value of an underlying asset, commodity or market indicator, the step of identifying the binary variable requires identifying the underlying asset commodity or market indicator as well as defining a threshold value. For example, a CBOE Sweet Crude Oil derivatives contract may be based on the price of a barrel of West Texas intermediate crude oil for delivery in Cushing, Okla. as published by the Department of Energy (DOE) on the last day of each month. Thresholds values may be established at even intervals, e.g., $48, $50, etc., with a first threshold being established at an even interval closest to the last price published by the DOE for West Texas crude. If desired, additional thresholds may be established above and below this value, and may serve as the basis for additional series of digital derivatives contracts. For example, if the DOE published a price of $47.50, a first threshold may be defined as $48 and three additional threshold values may be established above this value at $50, $52, and $54 and three below at, $42, $44, and $46. A binary variable may then be defined for each threshold value. In this case, the binary variable for each threshold may be defined by the question: “Is the price of West Texas sweet crude published by the DOE at the end of a specified month greater than $42, $44, $467 $48, $50, $52, or $54?” Each of these binary variables may serve as the basis for a separate series of digital derivatives contracts.

Once the binary variable has been defined, the exchange defines a standard digital derivatives contract (step S2) based on the defined variable. The standard contract created by the exchange will define the terms of the actual individual contracts that investors will enter when placing orders to take positions in the digital derivatives contracts. All of the details of the instrument must be spelled out. The binary variable must be defined; the settlement amounts established; the length of the contract; the date, possibly even the time when the binary variable will be evaluated; when and where the contracts may be traded; pricing conventions; delivery; and so forth. Using the example of CBOE Sweet Crude Digital Derivatives, the underlying variable may be defined as described above with settlement amounts of, for example, $1000 or $0 depending on whether the DOE published month end price is at or above the specified threshold value or not. The trading platform may be, for example, the electronic trading platform CBOEdirect® which allows trading between the hours of 8:30 A.M.-3:15 P.M. Central Standard Time. Contract trading may be limited monthly contracts, i.e., digital derivatives contracts that settle at the end of each month. The standard contract may set pricing conventions such as the granularity of price increments. For example, the CBOE Sweet Crude Oil derivatives prices may be limited to multiples of $10, e.g., $400, $410, $420, and so forth, while the price of the underlying commodity, West Texas Sweet Crude, is stated to two decimal places, e.g., $48.25. A minimum tick size such as $10 may also be established. Further contingencies can be spelled out, such as what will the impact of the DOE revising its price after contracts have settled, or how contracts will be settled if the DOE fails to publish a price on the specified settlement date. Finally, delivery provisions may be spelled out. For example, the buyer may be required to deposit the entire negotiated price, and the seller the greater of the two settlement amounts less the negotiated price. The two accounts may then be marked-to-market on a daily basis based on changes in the negotiated price. However, the accounts may be set up such that investors may not withdraw their funds until the business day after the final settlement date to ensure that sufficient funds are available to cover the contract.

Step S3 from FIG. 1 may be accomplished by listing one or more defined contracts on an exchange or trading platform. Listing a contract includes disseminating information about the contract to potential investors and providing a contracts. The CBOE Sweet Crude or Digitals of the present example may be traded on the CBOEdirect electronic trading platform. CBOEdirect is a trading facility which disseminates information regarding contracts traded on the platform, and allows brokers and dealers to place orders for customers who enter bids and make offers to buy and sell positions in such contracts.

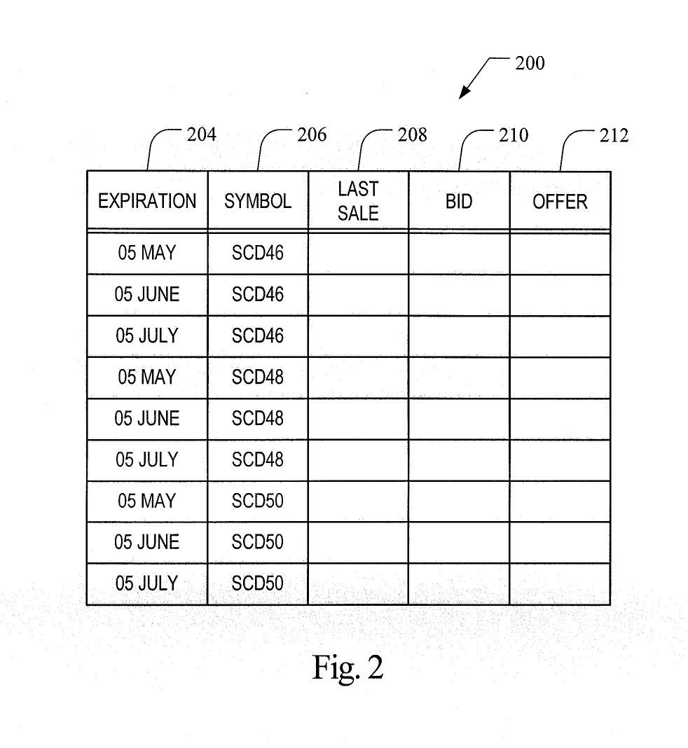

FIG. 2 is a sample listing 200 for CBOE Sweet Crude Oil derivatives The listing 200 includes a plurality of different CBOE Sweet Crude Oil derivatives contracts 202. Each contract includes a series expiration date 204, a trading symbol 206; a last sale price 208, a current bid 210, current offer 212. In the sample listing 200, the trading symbols SCD all refer to CBOE Sweet Crude Oil digital derivatives. The number following the symbol refers to the binary threshold for determining the settlement amount. The expiration 204 indicates the month at the end of which the contract will settle. The listing 200 includes three series of digital derivatives contracts based on a sweet crude oil price threshold of $46. One that settles at the end of May 2005, one that settles the end of June and one that settles the end of July. The listing 200 further includes Sweet Crude Oil derivatives having May, June and July expirations and having price thresholds of $50.

Essentially, once a contract is defined and listed, the CBOEdirect electronic trading platform, in conjunction with other backend systems of the exchange, is responsible for all of the remaining steps of the method 100 shown in FIG. 1. CBOEdirect accepts bids and offers from investors or brokers (Step S4), and executes marketable orders by matching buyers to sellers (Step 85. Other backend systems operated by the exchange evaluate the binary variables (Step S6) and settle the contracts at expiration (Step S7).

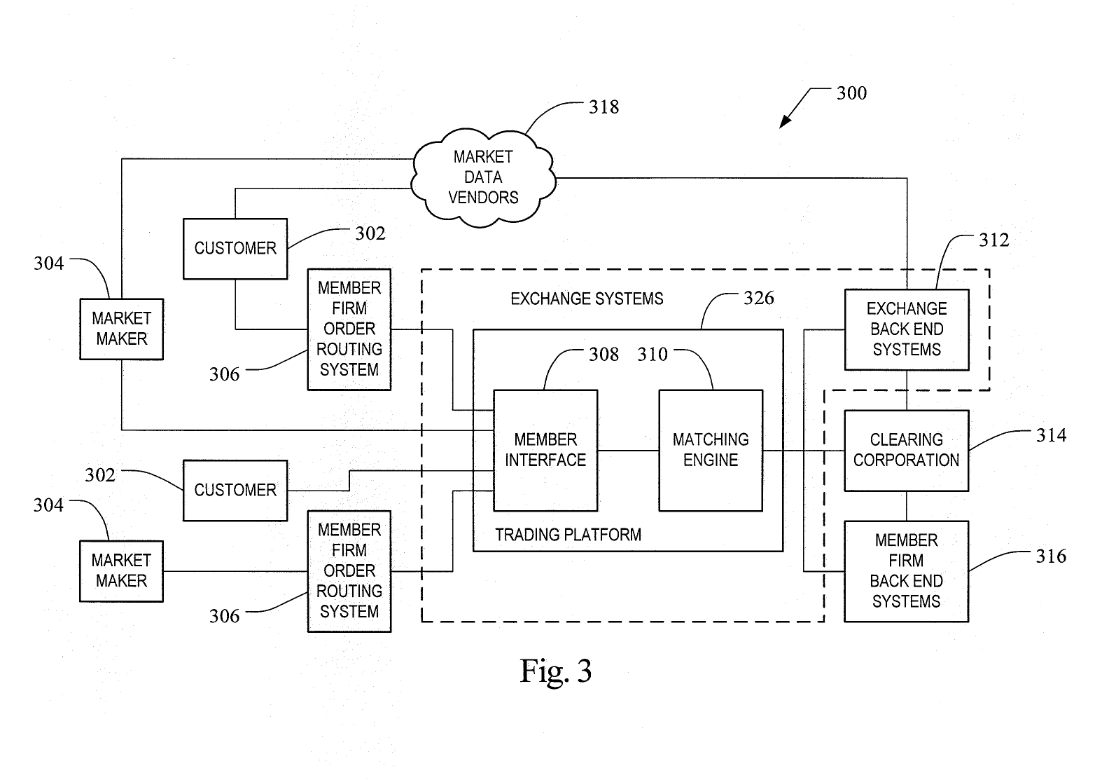

FIG. 3 shows an electronic trading system 300 which may be used for listing and trading digital derivatives contracts. The system 300 includes components operated by an exchange, as well as components operated by others who access the exchange to execute trades. The components shown within the dashed lines are those operated by the exchange. Components outside the dashed lines are operated by others, but nonetheless are necessary for the operation of a functioning exchange. The exchange components of the trading system 300 include an electronic trading platform 320, a member interface 308, a matching engine 310, and backend systems 312, Backend systems which may not necessarily be operated by the exchange but which are typically involved in processing trades and settling contracts are the clearing systems 314, and member firms' backend systems 316. One suitable third party clearing system is the Options Clearing Corporation.

Market makers may access the trading platform 320 directly through personal input devices 304 which communicate with the member interface 308. Market makers may quote prices for digital derivatives contracts. Non-member customers 302, however, must access the exchange through a member firm. Customer orders are routed through member firm routing systems 306. The member firms' routing systems 306 forward the orders to the exchange via the member interface 308. The member interface 308 manages all communications between the member firm routing systems 306 and market makers' personal input devices 304; determines whether orders may be processed by the trading platform; and determines the appropriate matching engine for processing the orders. Although only a single matching engine 310 is shown in FIG. 3, the trading platform 320 may include multiple matching engines. Different exchange traded products may be allocated to different matching engines for efficient execution of trades When the member interface 302 receives an order from a member firm routing system 306, the member interface 308 determines the proper matching engine 310 for processing the order and forwards the order to the appropriate matching engine. The matching engine 310 executes trades by pairing corresponding marketable buy/sell orders. Non-marketable orders are placed in an electronic order book.

Once orders are executed, the matching engine 310 sends details of the executed transactions to the exchange backend systems 312, to the clearing corporation systems 314, and to the member firms' backend systems 316. The matching engine also updates the order book to reflect changes in the market based on the executed transactions. Orders that previously were not marketable may become marketable due to changes in the market. If so, the matching engine 310 executes these orders as well.

The exchange backend systems 312 perform a number of different functions. For example, contract definition and listing data originate with the exchange backend systems 312. Pricing information for digital derivatives contracts is disseminated from the exchange backend systems to market data vendors 318. Customers 302, market makers 304, and others may access the market data regarding digital derivatives contracts via, for example, proprietary networks, on-line services, and the like. The exchange backend systems also evaluate the binary variable on which the digital derivatives contracts are based. At expiration, the backend systems 312 determine the appropriate settlement amounts and supply final settlement data to the clearing system 314. The clearing system acts as the exchange's bank and performs a final mark-to-market on member firm margin accounts based on the positions taken by the member firms' customers. The final mark-to-market reflects the final settlement amounts for the digital derivatives and the clearing system 314 debits/credits member firms' accounts accordingly. These data are also forwarded to the member firms' systems 316 so that they may update their customer accounts as well.

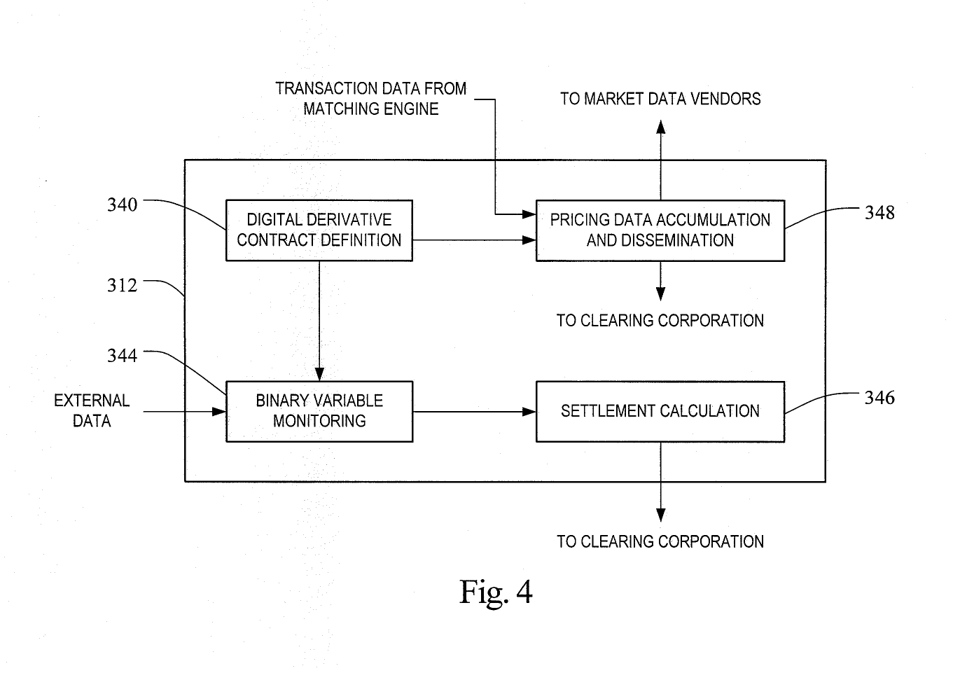

FIG. 4 shows the exchange backend systems 312 for trading digital derivatives in more detail. A digital derivatives contract definition module 340 stores all relevant data concerning the digital derivatives contract to be traded on the trading platform 320, including the contract symbol, the definition of the binary variable, the underlying asset (if there is one) the threshold value, or the event description, etc. A pricing data accumulation and dissemination module 348 receives contract information from the digital derivatives contract definition module 340 and transaction data from the matching engine 310. The pricing data accumulation and dissemination module 348 provides the market data regarding open bids and offers and recent transactions to the market data vendors 318. The pricing data accumulation and dissemination module 348 also forwards transaction data to the clearing system 314 so that the clearing system may mark-to-market the accounts of member firms at the close of each trading day, taking into account current market prices for the digital derivatives contracts. Finally, a settlement calculation module 346 receives input from the binary variable monitoring module 344. On the settlement date the settlement calculation module 346 calculates the settlement amount based on the state of the binary variable. The settlement calculation module 346 forwards the settlement amount to the clearing system which performs a final mark-to-market on the member firms' accounts to settle the digital derivatives contract.

The method of creating and trading digital derivatives contracts and the system for trading such contracts provides investors with a vehicle where they may isolate a single binary event and take a position relative to their estimate of whether the event will occur or will not occur. Thus, investors will be able to take positions relative to the events themselves rather taking indirect positions in the expected effects the occurrence or non-occurrence of the event will cause. The ability to take positions regarding such binary events allows investors to more accurately and efficiently manage risk.

A digital derivative contract may be structured as a digital option or futures contract and trade on an exchange as described above for a digital derivatives contract. Typically, a digital option contract is structured so that the option pays out a specified amount if the option expires in-the-money, or pays out nothing if the option expires out-of-the-money.

In one embodiment, the digital option contract is a digital put option contract based on an underlying asset or economic indicator with a strike price based on the current price of the underlying asset. At expiration of the digital put option contract, the option pays out a specified amount if the strike price is greater than or equal to the value of the underlying asset at expiration of the digital put option contract. However, if the strike price is less than the value of the underlying asset at expiration of the digital put option contract, the option pays out nothing.

In another embodiment, the digital option contract is a digital call option contract based on an underlying asset with a strike price based on the current price of the underlying asset. At expiration of the digital call option contract, the option pays out a specified amount if the strike price is less than or equal to the value of the underlying asset at expiration of the digital call option contract. However, if the strike price is greater than the value of the underlying asset at expiration of the digital call option contract, the option pays out nothing.

A hypothetical digital option contract could be created around the binary question “Will General Motors have a credit event, such as failing to pay on any of a specified set of its publicly traded debt or filing for bankruptcy, by the end of the second quarter of the present year?” Such is an example of a credit default contract that preferably settles in cash, based on the confirmation of the credit event in a “Reference Entity,” in a basket of Reference Entities, or in any Reference Entity that is a component of a specified basket of Reference Entities. As used herein, basket refers to a collection or grouping. A Reference Entity includes, but is not limited to, a U.S. corporation or a sovereign entity (e.g. country) reporting to the SEC. Such a Reference Entity has a credit event if, between the listing date and the close of the last day of trading, (1) it fails to pay on any of a specified set of its publicly traded debt or (2) it files for bankruptcy. In an embodiment, the exchange confirms credit events documented by (a) bankruptcy filings, (b) SEC 8K filings (for U.S. corporations) or SEC 6K filings (for sovereign entities), or (c) news releases from any two of the following: Bloomberg Service, Dow Jones News Wire, Wall Street Journal, New York Times or the like.

In another embodiment, contracts are based on a credit default rating service's, such as Standard & Poor's, default ratings for corporate, sovereign, and quasi-sovereign entities (“Entities”). The credit default rating service (Standard & Poor's) promptly assigns a rating of SD (selective default) or D (default) if an Entity fails to pay on one or more of its debt obligations. Preferably, either an SD or a D would qualify as a default. The conditions under which an Entity would be deemed to be in default closely match the conditions under which the credit default swap market would determine that this Entity has been affected by a credit event. In the U.S. market for credit default swaps, a credit event is deemed to occur if the Entity fails to pay on specified debt obligations or goes into bankruptcy.

The answer to the aforementioned example question relating to a credit event for General Motors will be known on July 1, and it will be either yes or no. The investors entering into such a digital contract may agree on settlement amounts of $0 if General Motors does not have a credit event and $100 if General Motors has such a credit event. Further, the first investor may be willing to pay the second investor a predetermined amount for the right to receive either $0 or $100 depending on whether the General Motors has a credit event by July 1 or not. If by July 1 General Motors does not have a credit event, the first investor pays the second investor the predetermined amount and the second investor owes the first investor nothing. Thus, the second investor, who took a short position in the contract, makes a profit corresponding to the predetermined amount. The first investor, who took the long position, suffers a loss corresponding to the predetermined amount.

Conversely, if General Motors does in fact have a credit event by July 1, the first investor is still obligated to pay the predetermined amount to the second investor, but now the second investor is obligated to pay the second settlement amount of $100. The predetermined amount owed by the first investor may be deducted from the amount owed by the second investor. Thus, the second investor need actually pay only the difference to the first investor and the first investor need actually pay nothing. In this case the second investor suffers a loss and the first investor sees a gain. Thus in the present example, the first investor has placed the predetermined amount at risk with the opportunity to realize a gain (offset by the predetermined amount), whereas the second investor takes on risk with the opportunity to realize a gain of the predetermined amount.

Another hypothetical digital option contract could be created around the binary question “Will Company X's Initial Public Offering (IPO) have a stock price that is $50?”

Such credit default contracts as described above may also be traded on an electronic parimutuel, or Dutch, auction system. Such an auction market would conduct periodic Dutch auctions, with market participants placing orders for digital option contracts that pay off a fixed dollar amount if an Entity is in default by settlement time and pay nothing otherwise. Multiple orders for multiple Entities in the auction pool may also be placed. All contracts that settle in-the-money are funded by the premiums collected for those that settle out-of-the-money. Thus, if General Motors were the only Entity in the pool to default, all participants who insured against a General Motors default would share the total premiums paid for the pool of Entities in the auction.

As mentioned, in a parimutuel auction, all the contracts that settle in-the-money are funded by those that settle out-of-the-money. Thus, the net exposure of the system therefore is zero once the auction process is completed, which means there is no accumulation of open interest over time. Additionally, the pricing of contracts depends on relative demand; the more popular the strike, the greater its value. In other words, a parimutuel action does not depend on market makers to set a price; instead the price is continuously adjusted to reflect the stream of orders coming into the auction. Preferably, as each order enters the system, it affects not only the price of the sought-after strike, but also all the other strikes available in that auction. In such a scenario, as the price rises for the more sought-after strikes the system adjusts the prices downward for the less popular strikes. Further, the process does not require the matching of specific buy orders against specific sell orders, as in many traditional markets. Instead all buy and sell orders enter a single pool of liquidity, and each order can provide liquidity for other orders at different strike prices and the liquidity is maintained such that system exposure remains zero. This format maximizes liquidity, a key feature when there is no tradable underlying instrument.

It is preferred that financial instruments for such a parimutuel auction be designed to pay a payout value, say one dollar, to the trader or investor if a particular outcome among a set of potential outcomes occurs. Potential outcomes are preferably those that fall within “states,” which are typically constructed from a distribution of potential outcomes (e.g., the default status of General Motors) owing to some real-world event. In such financial instruments, it is preferred that a set of states is chosen so that the states are mutually exclusive and the set collectively covers or exhausts all potential outcomes for the event. Thus, one state always occurs based on the outcome.

In another embodiment, contracts are related to, and in some cases based on terms of, credit default swaps (“CDSs”). A CDS is an over-the-counter (“OTC”) swap that provides for payments to be made by one party to the other upon the occurrence of a credit event with respect to a reference entity.

In effect, a CDS transfers the credit exposure to the reference entity from one party (the “Protection Buyer”) to the other party (the “Protection Seller”). A Protection Buyer makes periodic (quarterly, semi-annual or annual) fixed rate payments in an amount based on a quoted spread referred to as a “credit spread” or a “CDS spread.” The CDS spread represents the yield required by an investor to compensate it for the credit risk associated with the potential default of the issuer. A CDS spread is quoted in basis points and represents the amortized value of the expected payment to the Protection Seller per dollar of notional value of CDS contract if a credit event occurs prior to the expiration of the CDS.

For example, on Jun. 5, 2006, it was reported on Bloomberg that the closing value (which refers to the end-of-day value) for the five-year Ford senior debt security CDS was 870.25 basis points. Based on an assumed quarterly payment schedule, the Protection Buyer would pay $21,756.25 per $1 million face value ($21,756.25=$1,000,000*0.08702514) of Ford senior unsubordinated debt securities every three months to the Protection Seller. In return, the Protection Seller is required, upon the occurrence of a credit event with respect to the reference entity, to pay to the Protection Buyer either an agreed upon fixed amount or an amount determined by reference to the value of an identified security (referred to as the “reference obligation”) of the reference entity. In some cases the Protection Seller makes this payment in exchange for delivery of the Reference Obligation or some equivalent security by the Protection Buyer.

Thus, credit spread options (“CSOs”) are cash-settled option contracts that are based on and settle against an average of CDS spread mid-quotes of market participants at the close of the last day of trading. Each CSO generally specifies (a) the reference entity of the underlying CDS, (b) the specific debt security that serves as its reference obligation, (c) the definition of the credit event, and (d) the maturity of the CDS at the expiration of the option.

CSOs preferably have strike prices, and option prices, which are quoted in basis points. Each CSO preferably also has a contract multiplier, similar to index options. CSOs are preferably listed in near-term months followed by additional months in a quarterly cycle. If no bankruptcy is declared, or other credit event occurs prior to expiration, the options will expire on their scheduled expiration dates. If a bankruptcy is declared prior to the scheduled expiration, the options will cease to trade after the bankruptcy is confirmed. Alternatively, CSOs may also be structured as digital contracts and trade on an exchange as described above for a digital futures or options contracts.

The following is illustrative of an example of how CSOs could trade: suppose that on Aug. 19, 2005, an investor wanted to buy an at-the-money CSO call expiring on Sep. 20, 2005. On Aug. 19, 2005, the closing spread (or end-of-day spread) of a five-year CDS on Delphi was 800.35 basis points. Also suppose that on Aug. 19, 2005, the listed strike closest to 800.35 was 800. On Sep. 20, 2005, the spread of the Delphi CDS closed at 1825.823 and the 800 strike call option would have settled against that closing spread.

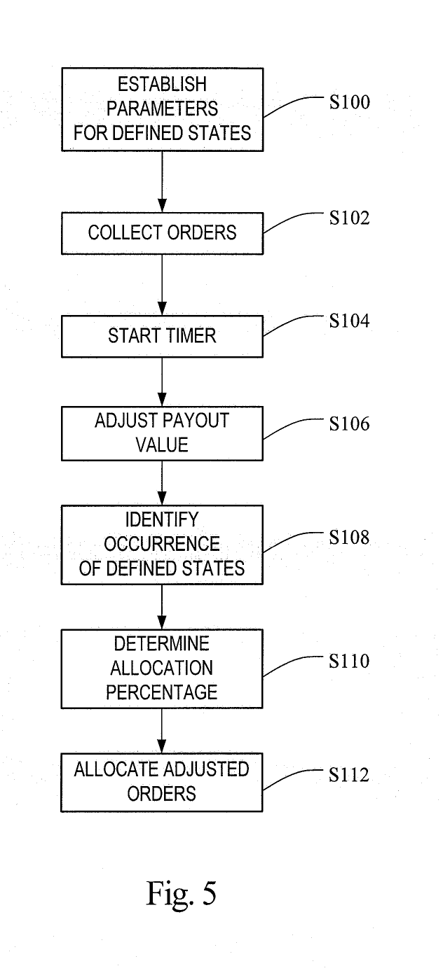

In an embodiment illustrated in FIG. 5, a method for conducting a parimutuel automated auction is shown generally including a step S100 for establishing parameters for at least one defined state corresponding to at least one potential outcome for a selected financial instrument. Another step (S102) is for collecting, prior to an occurrence of the at least one potential state, orders comprising at least one defined state, a size and a payout value associated therewith for the selected financial instrument and storing the orders in an electronic database. A timer for timing the auction is started at step S104. The payout value of the selected financial instrument corresponding to the size of orders entered by at least one market participant for the selected financial instrument is adjusted before an expiration of the timer at step S106. The duration of the timer may be set as desired, for example in terms of seconds, minutes or days. The occurrence of the at least one defined state is identified before the expiration of the timer at step S108. At step S110 an allocation percentage of the orders for allocating the selected financial instrument stored in the electronic database among market participants is determined by calculating a participation component and a pro rata component for each market participant. The orders having the adjusted payout value in the electronic database are allocated at step S112 by multiplying the determined allocation percentage for each respective market participant by an adjusted value component comprising a change in value between the payout value and the adjusted payout value of the entered orders. In accordance with the principles of a parimutuel auction, the adjusted payout value is zero for orders having the at least one defined state that did not occur before the expiration of the timer and the sum of all adjusted payout values for orders having at least one defined state that did occur is less than or equal to a total payout value for all orders.

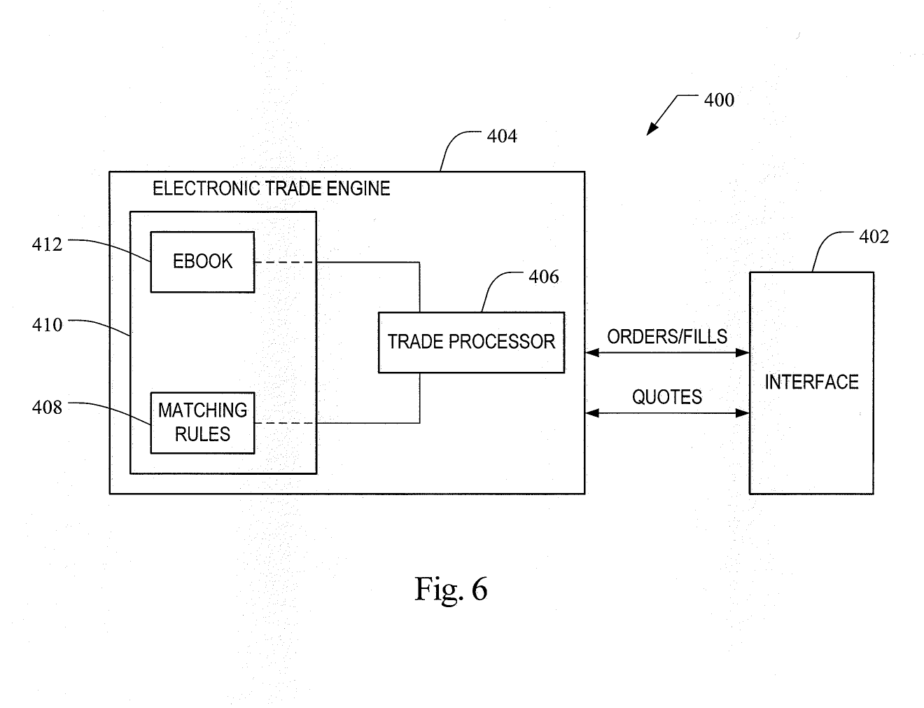

As illustrated in FIG. 6, an automated exchange 400 configured for parimutuel auctioning of a selected financial instrument by a combination of electronic and open-outcry trading mechanisms is shown. Preferably, the automated exchange is based on the exchange system disclosed in U.S. application Ser. No. 10/423,201, filed Apr. 24, 2003, entitled “HYBRID TRADING SYSTEM FOR CONCURRENTLY TRADING SECURITIES OR DERIVATIVES THROUGH BOTH ELECTRONIC AND OPEN-OUTCRY TRADING MECHANISMS,” and this application is incorporated in its entirety by reference herein. The automated exchange 400 includes a data interface 402 for receiving an incoming order to purchase the selected financial instrument and routing the order to a electronic trade engine 404 that contains a processor means 406, such as trade processor, that analyzes and manipulates orders according to matching rules 408 stored in a system memory means 410, such as a database, in communication with the processor means 406. The data interface 402 performs various functions, including but not limited to, error checking, data compression, encryption and mediating the exchange of data between the exchange 400 and entities sending orders and/or quotes. Orders and quotations from the market participants are placed on the exchange 400 via the interface 402.

Also included in the electronic trade engine 404 is the electronic book memory means 412 (EBOOK) of orders and quotes with which incoming orders to buy or sell are matched with quotes and orders resting on the EBOOK 412 according to the matching rules 408. The electronic trade engine 404 may be a stand-alone or distributed computer system. Any of a number of hardware and software combinations configured to execute the trading methods described below may be used for the electronic trade engine 404. In one embodiment, the electronic trade engine 404 may be a server cluster consisting of servers available from Sun Microsystems, Inc., Fujitsu Ltd. or other known computer equipment manufacturers. The EBOOK 412 portion of the electronic trade engine 404 may be implemented with Oracle database software and may reside on one or more of the servers comprising the electronic trade engine 404. The rules database 408 may be C++ or java-based programming accessible by, or executable by, the processor means 406.

Preferably, the incoming order has a size and a payout value associated therewith and is stored in the book memory means 412. The book memory means 412 is also for storing previously received orders, which also have a size and a payout value associated therewith. The system memory means 410 is included for storing predefined condition parameters for at least one defined state corresponding to at least one potential outcome for the selected financial instrument (described above) and allocating parameters for allocating orders among market participants. A timer means (not shown) is preferably also utilized for timing the parimutuel auction, the auction including a beginning time and an expiration time. Additionally, a processor means 406 is included for allocating orders among the previously received orders in the book memory means 412 based on the condition and allocating parameters in the system memory means 410. It is preferred that the condition parameters include at least one parameter for identifying an occurrence of at least one defined state occurring before the expiration time. It is further desirable to have the allocating parameters include parameters for allocating preferentially against orders with larger size, time-priority, or parameters for calculating an allocation percentage based on a formula that allocates the order identified with the at least one market participant. Such a formula may be:
X%=siz[mp]/(siz[mp]+siz[pro])

where siz[mp] is the size of the order identified with the at least one market participant, and size[pro] is the sum of the sizes of professional orders not identified with the at least one market participant.

Further, the processor means 406 may be used for calculating a zero payout value for orders having the at least one defined state that did not occur before the expiration of the timer and a greater than zero payout value for orders having at least one defined state that did occur, wherein the sum of all payout values for orders having at least one defined state that did occur is less than or equal to a total payout value for all orders.

While various embodiments have been described, it will be apparent to those of ordinary skill in the art that many more embodiments and implementations are possible within the scope of the invention. Accordingly, it is intended that the foregoing detailed description be regarded as illustrative rather than limiting, and that it be understood that the following claims, including all equivalents, are intended to define the scope of this invention.

1. A method of trading a financial instrument comprising:
identifying an initial public offering as a basis of a digital option contract;
establishing the digital option contract in which an investor will receive one of a first settlement amount and a second settlement depending on whether a strike price of the digital option contract is less than, equal to, or greater than a share value of the initial public offering at expiration of the digital option contract;
determining whether the strike price of the digital option contract is less than, equal to, or greater than the share value of the initial public offering at expiration of the digital option contract; and
settling the digital option contract according to whether the strike price of the digital option contract is less than, equal to, or greater than the share value of the initial public offering at expiration of the digital option contract.

2. The method according to claim 1, wherein the digital option contract comprises a digital call option contract and wherein the method further comprises;
allocating the first settlement amount to the investor if the strike price of the digital call option contract is less than or equal to the share value of the initial public offering at expiration of the digital call option contract; and
allocating the second settlement amount if the strike price of the digital call option contract is greater than the share value of the initial public offering at expiration of the digital call option contract.

3. The method according to claim 2, wherein the first settlement amount is a non-zero value and the second settlement amount is zero.

4. The method according to claim 1, wherein the digital option contract comprises a digital put option contract, and wherein the method further comprises:
allocating the first settlement amount to the investor if the strike price of the digital call option contract is greater than or equal to the share value of the initial public offering at expiration of the digital put option contract; and
allocating the second settlement amount to the investor if the strike price of the digital call option contract is less than the share value of the initial public offering at expiration of the digital put option contract.

5. The method according to claim 4, wherein the first settlement amount is a non-zero value and the second settlement amount is zero.

6. A computer-readable medium comprising processor executable program instructions for executing the steps of:
identifying an entity subject to an initial public offering;
establishing a digital derivative contract in which an investor will receive one of a first settlement amount and a second settlement amount depending on whether a strike price of the digital derivative contract is less than, equal to, or greater than a share value of the initial public offering; and
settling the digital derivative contract according to whether the strike price of the digital derivative contract is less than, equal to, or greater than the share value of the initial public offering at expiration of the digital derivative contract.

7. The computer-readable medium of claim 6, wherein the digital option contract comprises a digital call option contract, the computer-readable medium further comprising processor executable instructions for:
allocating the first settlement amount to an investor if the strike price of the digital call option contract is less than or equal to the share value of the initial public offering at expiration of the digital call option contract; and
allocating the second settlement amount if the strike price of the digital call option contract is greater than the share value of the initial public offering at expiration of the digital call option contract.

8. The computer-readable medium of claim 6, further comprising processor executable instructions for allocating a non-zero value for the first settlement amount and a zero value for the second settlement amount.

9. The computer-readable medium of claim 6, wherein the digital option contract comprises a digital put option contract, the computer-readable medium further comprising processor executable instructions for:
allocating the first settlement amount to the investor if the strike price of the digital call option contract is greater than or equal to the share value of the initial public offering at expiration of the digital put option contract; and
allocating the second settlement amount to the investor if the strike price of the digital call option contract is less than the share value of the initial public offering at expiration of the digital put option contract.

10. The computer-readable medium according to claim 9, further comprising processor executable instructions for allocating a non-zero value for the first settlement amount and a zero value for the second settlement amount.

11. An exchange configured for trading a digital derivative investment instrument based on an underlying initial public offering share value by a combination of electronic and open-outcry trading mechanisms, comprising:
an interface for receiving an incoming order to purchase the digital derivative investment instrument based on the underlying initial public offering share value, the incoming order having a size and a payout value associated therewith;
a book memory for storing a plurality of previously received orders, the previously received orders each having a size and a payout value associated therewith;
a system memory for storing predefined condition parameters for at least one defined state corresponding to at least one potential outcome for the digital derivative investment instrument; and
a processor adapted to allocate orders among the plurality of previously received orders in the book memory based on the condition parameters, wherein the condition parameters include at least one parameter for identifying an occurrence of at least one defined state occurring before the expiration; and
the processor further adapted to calculate a zero payout value for orders having the at least one defined state that did not occur before an expiration of the digital derivative investment instrument based on the underlying initial public offering share value and a greater than zero payout value for orders having at least one defined state that did occur prior to the expiration of the digital derivative investment instrument based on the underlying initial public offering share value.

12. The exchange of claim 11, wherein the system memory further comprises allocating parameters for allocating orders among market participants.

13. The exchange of claim 12, wherein the processor is further configured to allocate the previously received orders based on the allocating parameters in the system memory and wherein the allocating parameters include parameters for allocating preferentially against orders with larger size.

14. The exchange of claim 13, wherein the digital derivative investment instrument based on the underlying initial public offering share value comprises a digital option contract.

15. The exchange of claim 13, wherein the digital derivative investment instrument based on the underlying initial public offering share value comprises a digital futures contract.

16. The exchange of claim 13, further comprising a clearing system in communication with the processor, the clearing system adapted to settle the digital derivative investment instrument based on the underlying initial public offering share value.
